(19) United States
(12) Patent Application Publication
(10) Pub. No.: US 2004/0252685 A1
(43) Pub. Date: Dec. 16, 2004

(54) Channel adapter with integrated switch

(75) Inventors: Michael Kagan, Zichron Yaakov (IL); Freddy Gabbay, Tel Aviv (IL); Peter Peneah, Nesher (IL); Alon Webman, Tel Aviv (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mellanox Technologies Ltd., Yokneam (IL)

(21) Appl. No.: 10/461,676

(22) Filed: Jun. 13, 2003

(51) Int. Cl. H04L 12/56

(52) U.S. Cl. 370/389; 370/463

(57) ABSTRACT

Apparatus for interfacing a computing device with a network includes a switch and an interface adapter. The interface adapter includes packet generation circuitry, for preparing a packet for transmission onto the network through the switch, and a buffer, coupled to receive and store the packet prepared by the packet generation circuitry. An output interface, coupled between the buffer and a first port of the switch, submits a notification to the first port that the packet has been prepared in the buffer. Upon receiving a response from the first port indicating that a second port of the switch, connected to the network, is ready to transmit the packet, the output interface conveys the packet to the first port, whereupon the first port passes the packet to the second port for transmission onto the network.

### FIELD OF THE INVENTION

The present invention relates generally to digital network communications, and specifically to network adapters and switches for interfacing between a host processor and a packet data network.

### BACKGROUND OF THE INVENTION

In high-speed packet switches, large store-and-forward buffers are typically needed in order to ensure the smooth flow of packets through the switch and full exploitation of the available network wire speed, while avoiding packet discard and bottlenecks due to buffer overflow. Arriving packets that cannot be delivered immediately because of output port contention are stored in a buffer (or buffers) within the switch until they can be delivered to the destination port. The memory volume required for the buffers is determined by the statistical fluctuations in the arrival patterns of the input packets at the switch ports and the service rate within the switch. The service rate is a function of the distribution of the packets among the ports for output and the internal speedup provided by the switch.

A variety of different switch architectures are known in the art, implementing different methods of buffering. Output queuing, in which the packets are stored in buffers at the ports through which they are to be output, is conceptually the simplest approach. In an N-port switch constructed according to this scheme, each output port maintains N buffers, one for each input port, giving N² buffers in total. This approach is too costly for most applications due to the large volume of memory required. Input queuing is more memory-efficient, requiring only N buffers in total. In this scheme, a single buffer is maintained at each input port, and a packet is switched out of the buffer only when its designated output port is ready to accept it. Even when input queuing is used, however, the large volume of memory required is still a very significant factor in the cost of the switch.

High-speed packet switches are a crucial part of new system area networks (SANS) and fast, packetized, serial input/output (I/O) bus architectures, in which computing hosts and peripherals are linked by a network of switches, commonly referred to as a switch fabric. A number of architectures of this type have been proposed, culminating in the “InfiniBand™” (IB) architecture, which is described in detail in the InfiniBand Architecture Specification, Release 1.1 (November, 2002), which is incorporated herein by reference. This document is available from the InfiniBand Trade Association at www.infinibandta.org. Computing devices (host processors and peripherals) connect to the IB fabric via a network interface adapter, which is referred to in IB parlance as a channel adapter. Host processors (or hosts) use a host channel adapter (HCA), while peripheral devices use a target channel adapter (TCA).

As in other packet networks, each TB packet transmitted by a computing device via its channel adapter carries a media access control (MAC) destination address, referred to as a Local Identifier (LID). The LID is used by switches in a subnet of the fabric to convey the packet to its destination. Each IB switch maintains a Forwarding Table (FT), listing the correspondence between the LIDs of incoming packets and the output ports of the switch. When the switch receives a packet at one of its ports, it looks up the LID of the packet in its FT in order to determine the destination port through to which the packet should be switched for output. Similar look-up schemes are used in other networks.

Each IB packet also has a Service Level (SL) attribute, indicated by a corresponding SL field in the packet header, which permits the packet to be transported at one of 16 service levels. Different service levels can be mapped to different data virtual lanes (VLs) in the fabric, which provide a mechanism for creating multiple virtual links within a single physical link. A virtual lane represents a set of transmit and receive buffers in a network port. The port maintains separate flow control over each VL, so that excessive traffic on one VL does not block traffic on another VL. The VLs can also be used to set quality-of-service (QoS) policies for resolving content on among different packets at the network switches. The actual VLs that a port uses are configurable, and can be set based on the SL field in the packet, so that as a packet traverses the fabric, its SL determines which VL will be used on each link.

### SUMMARY OF THE INVENTION

It is an object of some aspects the present invention to provide improved devices and methods for switching packets that are transmitted over a switch fabric by a computing device.

It is a further object of some aspects of the present invention to provide a packet switch with substantially reduced requirements for buffer memory size.

In preferred embodiments of the present invention, a computing device is coupled to a packet network by an interface adapter, which has an output interface to an access port of a network access switch. The switch typically has one or more access ports connected to the interface adapter, along with a plurality of network ports connecting to the network. The switch implements an input queuing scheme at the access ports, but unlike switches known in the art, the access ports have substantially no internal buffers. Instead, the access ports use a novel signaling scheme to interact with one or more internal buffers of the interface adapter. These buffers must in any case be provided in the adapter to hold outgoing packets waiting for transfer to the access port. In this way, the internal buffers of the adapter are made to serve in place of the input buffers that are required in high-speed packet switches known in the art.

Typically, the adapter prepares the outgoing packets for transmission cover the network, in response to work requests submitted by the computing device, and places the packets in its internal buffer to await transmission. An output interface of the adapter notifies the access port of the packets waiting in the buffer. For each of the packets in the buffer, the access port checks to determine the network port through which it should be output When this output port signals the access port that it is ready to transmit a packet, the access port signals the output interface of the adapter to read out the proper packet from the buffer. The packet is then conveyed immediately from the access port to the network port, and from there onto the network, with no need to buffer the packet at either the access (input) port or the network (output) port.

There is therefore provided, in accordance with a preferred embodiment of the present invention, apparatus for interfacing a computing device with a network, including:

a switch, including a plurality of ports, including at least first and second ports; and

an interface adapter, configured to receive data from the computing device for transmission over the network, the interface adapter including:

packet generation circuitry, adapted to prepare a packet containing the data and destined to be transmitted onto the network through the second port;

a buffer, coupled to receive and store the packet prepared by the packet generation circuitry; and

an output interface, coupled between the buffer and the first port of the switch, and adapted to submit a notification to the first port that the packet has been prepared in the buffer, and upon receiving a response from the first port indicating that the second port is ready to transmit the packet, to convey the packet to the first port, whereupon the first port passes the packet to the second port for transmission onto the network.

Preferably, the switch is configured so that the first port, upon receiving the packet from the output interface, passes the packet to the second port substantially without buffering the packet in the switch.

In a preferred embodiment, the notification submitted by the output interface includes a descriptor identifying a destination address of the packet on the network, and the switch is adapted, responsive to the descriptor, to determine that the packet should be passed to the second port for transmission. Preferably, the descriptor further identifies a service level of the packet, and the switch is adapted, responsive to the service level, to select a virtual link on which the packet is to be transmitted from the second port.

In a preferred embodiment, the network includes a switch fabric, and the interface adapter includes a channel adapter.

There is also provided, in accordance with a preferred embodiment of the present invention, apparatus for interfacing a computing device with a network, including:

an interface adapter, configured to receive data from the computing device for transmission over the network, the interface adapter including:

packet generation circuitry, adapted to prepare a packet containing the data;

a buffer, coupled to receive and store the packet prepared by the packet generation circuitry; and

an output interface, coupled to read the packet from the buffer; and

a switch, including:

a network port, connected to the network; and

an access port, coupled to receive an indication from the network port that the network port is ready to transmit the packet onto the network, and further coupled to signal the output interface, responsive to the indication, that the switch is ready to receive the packet, so that the output interface passes the packet to the access port, and the access port conveys the packet to the network port for transmission onto the network.

Preferably, the access port is adapted to receive a notification from the output interface indicating that the packet has been prepared in the buffer, and to signal the output interface that the switch is ready to receive the packet responsive to the notification. Further preferably, the notification includes a descriptor identifying a destination address of the packet on the network, and the access port is adapted, responsive to the descriptor, to select the network port to which the packet should be passed for transmission. Most preferably, the descriptor further identifies a service level of the packet, and the access port is adapted, responsive to the service level, to select a virtual link on which the packet is to be transmitted from the network port.

Additionally or alternatively, the access port is adapted, responsive to the notification from the output interface, to request that the network port return the indication when it is ready to transmit the packet. Typically, the access port is one of a plurality of access ports that are adapted to convey packets to the network port, and the network port is adapted to determine an order of transmission among the access ports and to return the indication to the access port responsive to the determined order.

There is additionally provided, in accordance with a preferred embodiment of the present invention, a method for data communication, including:

preparing a packet containing data for transmission over a network via a switch having an input port and an output port connecting to the network;

storing the prepared packet in a buffer off the switch;

upon receiving an indication from the input port that the output port is ready to transmit the packet, conveying the packet to the input port; and

passing the packet through the switch from the input port to the output port for transmission onto the network.

Preferably, storing the prepared packet includes submitting a notification to the input port that the packet is ready for transmission, and the input port provides the indication that the output port is ready to transmit the packet responsive to the notification. Further preferably, the method includes, responsive to the notification, conveying a request from the input port to the output port to transmit the packet, and providing the indication that the output port is ready to transmit the packet upon receiving a response to the request from the output port. Most preferably, the method include arbitrating at the output port among a plurality of ports of the switch having packets to transmit, so as to determine an order of transmission among the ports, and returning the response from the output port to the input port responsive to the determined order.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a computer network, in accordance with a preferred embodiment of the present invention;

FIG. 2 is a block diagram that schematically illustrates a channel adapter and switch used in a computer network, in accordance with a preferred embodiment of the present invention;

FIG. 3 is a block diagram that schematically shows details of the channel adapter and switch of FIG. 2, in accordance with a preferred embodiment of the present invention;

FIG. 4 is a block diagram that schematically shows details of an input port in a network switch, in accordance with a preferred embodiment of the present invention; and

FIG. 5 is a flow chart that schematically illustrates a method for conveying packets from a channel adapter to a network, in accordance with a preferred embodiment of the present invention.

### DETAILED DESCRIPTION OF PREFERRED EMBODIMENTS

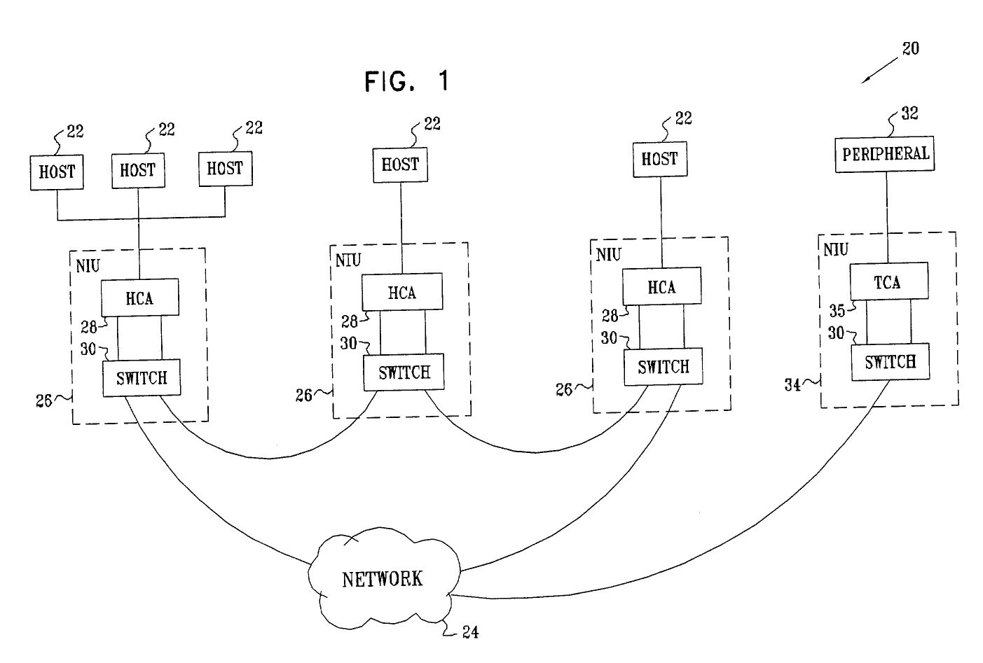

FIG. 1 is a block diagram that schematically illustrates an InfiniBand (IB) network communication system 20, in accordance with a preferred embodiment of the present invention. In system 20, host processors 22 are connected to an IB network (or fabric) 24 by network interface units (NIUs) 26. Each NIU comprises a host channel adapter (HCA) 28 and an integral access switch 30. The RCA and switch are preferably fabricated together on a single integrated circuit chip, although multi-chip implementations are also within the scope of the present invention. In like fashion, a peripheral device 32, such as an input/output (I/O) adapter or storage device, is connected to the network by a NIU 34, comprising a target channel adapter (TCA) 35 along with its integral switch 30.

Each NIU 26 is preferably capable of serving one or more computing devices (hosts or peripherals). In the exemplary embodiment shown in FIG. 1, a cluster of hosts 22 is served by a number of NIUs, which are linked to one another and to network 24 through network ports of their respective access switches 30. An advantage of this configuration is that it enables both efficient communication among the hosts in the cluster and redundant links to network 24. Other useful configurations based on NIUs 26 and 34 with integral switches 30 will be apparent to those skilled in the art.

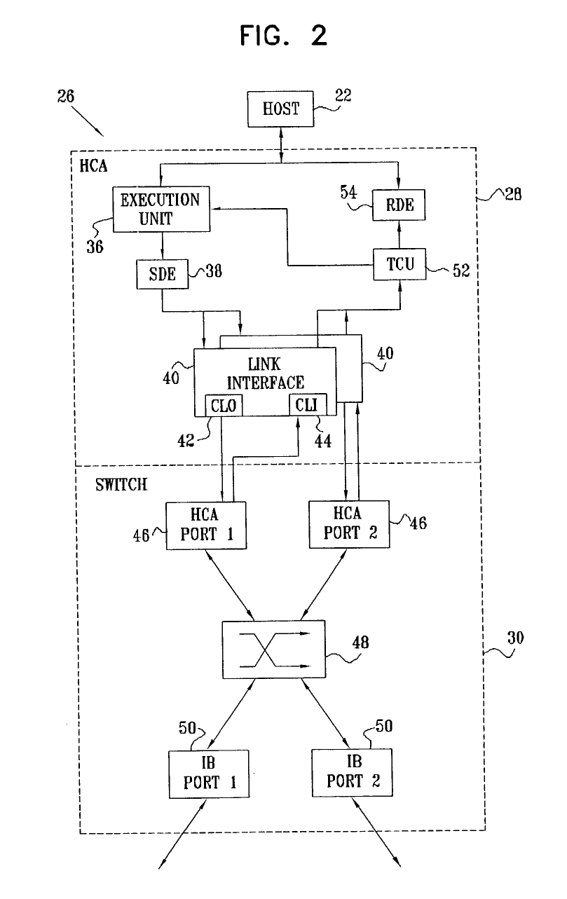

FIG. 2 is a block diagram that shows details of HCA 28 and switch 30 in NIU 26, in accordance with a preferred embodiment of the present invention. Host 22 initiates transmission of packets via switch 30 by submitting work requests (WRs) to HCA 28. Each WR defines a message to be transmitted by the HCA, as specified by the above-mentioned IB specification. An execution unit 36 processes each WR and generates corresponding gather entries, defining the packets to be sent over network 24 in order to convey the requested messages. The execution unit feeds the gather entries to a send data engine 38, which builds the actual packets and passes them to a link interface 40 for transmission. Further details of these elements of HCA 28 and their operation are provided in U.S. patent application Ser. No. 10/000,456, filed Dec. 4, 2001, and in U.S. patent application Ser. No. 10/052,435, filed Jan. 23, 2002. Both of these applications are assigned to the assignee of the present patent application, and their disclosures are incorporated herein by reference.

Link interface 40 communicates with an access port (or HCA port) 46 of switch 30. Preferably, HCA 28 is linked in parallel to two access ports 46 of the switch, using dual link interfaces 40 in the HCA, as shown in the figure. This arrangement affords enhanced efficiency and configurability of the connection between the HCA and the switch. Alternatively, larger numbers of ports and interfaces may be used. Even a single interface 40 and access port 46 are sufficient, however, for the purposes of the present invention, and the description that follows relates to only one interface/access port pair. Packets that are input to access ports 46 are conveyed by a switching core 48 for output via one of a plurality of network ports (or IB ports) 50. Although only two network ports are shown in FIG. 2, in practice switch 30 may have a greater number of network ports, depending on network configuration and switch design considerations.

Each link interface 40 is connected to its corresponding access port 46 by a channel link output (CLO) block 42 and a channel link input (CLI) block 44. CLO 42 passes packets generated by SDE 38 to port 46, which serves as the switch input port for these packets. For packets received from network 24 at network ports 50, access port 46 serves as the output port, conveying these packets to CLI 44. Such incoming packets are passed by link interface 40 to a transport check unit (TCU) 52. When the packets contain data to be conveyed to host 22, TCU 52 passes the packet contents to a receive data engine (RDE) 54, which typically writes the data to a memory accessible to the host (not shown in the figures). When an incoming packet from the network requests that data and/or an acknowledgment be returned to the sender of the packet, TCU 52 signals execution unit 36 to prepare the appropriate response packet (or packets). These elements and functions of HCA 28 are described in detail in the above-mentioned U.S. patent applications.

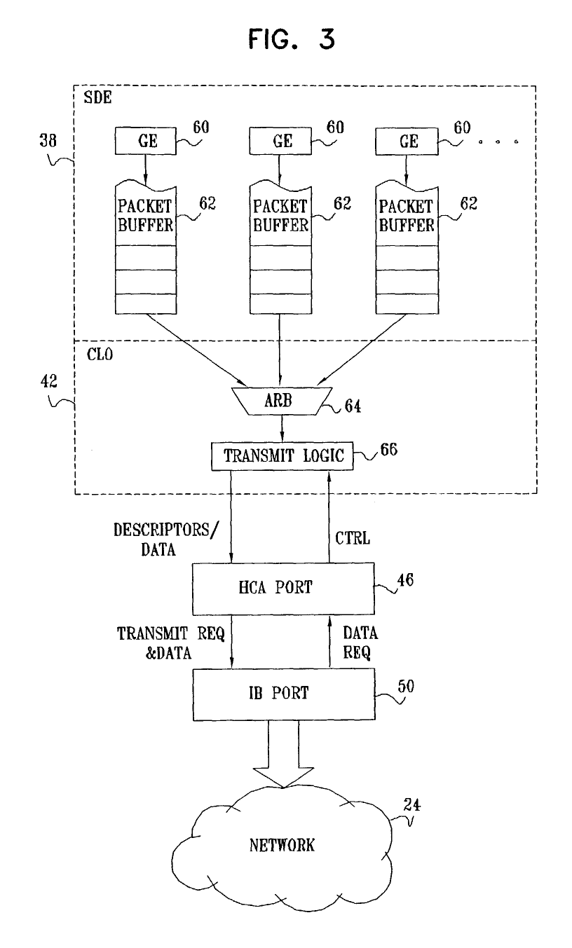

FIG. 3 is a block diagram showing further details of SDE 38 and CLO 42 that are pertinent to the flow of outgoing packets from HCA 28 to network 24, in accordance with a preferred embodiment of the present invention. For high-speed operation, the SDE and CLO are typically implemented in dedicated hardware logic, although the functions of these blocks may alternatively be carried out in software by an embedded processor. SDE 38 preferably comprises a plurality of gather engines 60, which operate in parallel to process the gather entries generated by execution unit 36. Typically, each gather engine is assigned to one of link interfaces 40, with multiple gather engines assigned together to each of the interfaces. The use of multiple parallel gather engines in this manner is meant to ensure that packets are always generated at least as fast as network 24 can accept them, so that HCA 28 takes full advantage of the wire speed of switch 30 and network 24. Most preferably, the gather entries are assigned to gather engines 60 based on an arbitration scheme described in the above-mentioned U.S. patent applications. Each gather entry either contains data (typically header data) to be entered by the gather engine directly in the packet it is building, or contains a pointer to data (typically payload data) to be retrieved by the gather engine from a system memory (not shown) for incorporation in the packet.

When one of gather engines 60 has completed building a packet, it places the packet in an output packet buffer 62. These buffers are needed in order to resolve contention by the gather engines for the resources of CLO 42. The gather engine signals the CLO that there is a packet in its buffer that is awaiting transmission. An arbiter 64 in the CLO selects the packets in buffers 62 to be serviced, preferably based on the respective service level (SL) fields in the packets. For each such packet, transmit logic 66 prepares a descriptor to submit to HCA port 46. The descriptor preferably contains the following information:

Destination address (known as the destination local identifier—DLID).

Service level (SL).

Packet length.

Packet ID (a control number assigned for identification to each packet awaiting transmission).

Additional fields may be added to the descriptor, for example, to identify special packet types, such as fabric management packets.

HCA port 46 processes each descriptor to determine the IB port 50 to which the packet is to be sent for output and the virtual lane (VL) on which the packet is to be transmitted. Based on this information, port 46 sends a packet transmission request to port 50. When port 50 indicates that it is ready to transmit the packet, port 46 sends a control signal to CLO 42, telling it to read the packet out of buffer 62 and pass it to port 46. The control signal identifies the packet by its packet ID, given in the descriptor generated previously by logic 66. The packet itself is then transferred by CLO 42 to port 46, and from there via switching core 48 to port 50, substantially without additional buffering. Alternatively, if HCA port 46 or TB port 50 determines that a given packet cannot be transmitted, due to an error in the packet, for example, port 46 signals CLO 42 that the packet should be discarded from buffer 62.

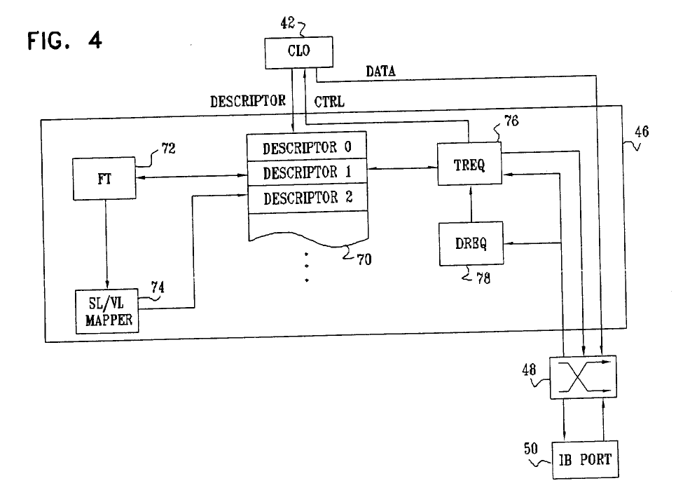

FIG. 4 is a block diagram that schematically shows details of HCA port 46, in accordance with a preferred embodiment of the present invention. This figure shows only elements of port 46 that are involved in processing outgoing packets generated by HCA 28. For these outgoing packets, port 46 serves as the input port to switch 30.

Descriptors submitted by CLO 42 are stored in a transmission list 70. As port 46 processes the descriptor information, it adds the processed information to the corresponding entry in list 70. A forwarding table (FT) machine 72 looks up the DLID of each packet to determine the network port 50 to which the packet should be forwarded for output. When the correct output port is identified, its identification is written to the corresponding entry in list 70, in place of the DLID. Multicast packets, identified by an appropriate multicast DLID, may be designated for output through multiple network ports of switch 30. Details of a preferred implementation of FT machine 72 are described in U.S. patent application Ser. No. 09/892,852, filed Jun. 28, 2001, whose disclosure is incorporated herein by reference. (Note that the FT is referred to in that application as a Forwarding Database—FDB.) Alternatively, the output port may be determined in advance by HCA 28, as would likely be the case in the cluster configuration shown in FIG. 1. In this case, CLO 42 simply signals FT machine 72 with the appropriate port number, and DLID lookup is unnecessary.

For each packet, a SL/VL mapper 74 in port 46 checks the SL value given by the descriptor in list 70 in order to determine the virtual lane (VL) on which the packet is to be transmitted by port 50. Mapper 74 preferably comprises a look-up table in random access memory (RAM), containing the SL/VL mapping for each of ports 50. This mapping may vary from port to port. The mapper writes the VL value for each of the ports to the entry in list 70, preferably overwriting the corresponding value given by the descriptor, which is no longer needed.

Once FT machine 72 and mapper 74 have finished processing an entry in list 70, HCA port 46 is ready to transfer the corresponding packet to the designated IB port 50. The actual transfer does not take place, however, unless the IB port has a sufficient number of credits (for flow control purposes) to transmit the packet over the appropriate link, and the VL arbitration mechanism at the ID port has chosen the VL of this packet (following SL/VL mapping) as the next VL for transmission.

Control of the transfer is handled by a transfer request (TREQ) machine 76 and a data transmission request (DREQ) machine 78. TREQ machine 76 requests permission of output port 50 to transfer the packet from port 46 to port 50, by indicating to port 50 the VL on which the packet is to be transmitted and the number of transmission credits to be consumed by the packet. (The number of credits required is determined by the packet length, as provided in the ID specification.) If IB port 50 is busy, it arbitrates among the different transmission requests that it receives, preferably using methods of VL arbitration known in the art. When port 50 is ready to accept the packet, it sends a signal back to port 46, which is received by DREQ machine 78. (Alternatively, the signal may indicate that port 50 cannot accept the packet, and the packet should be discarded.) DREQ machine 78 processes the signal and accordingly generates a control signal to CLO 42, indicating that it should now transmit (or discard) the packet from buffer 62.

Preferably, when port 50 determines that its transmit queue is idle and that network resources are available to transmit a packet of the maximum size allowed by the network, port 50 signals port 46 to indicate that it is idle. In this case, TREQ machine 76 sends a control signal to CLO 42 to begin transmitting the packet from buffer 62 immediately, as soon as the TREQ machine has submitted the transfer request. There is no need to wait for the DREQ machine to receive a response. The latency of packet transmission under light traffic conditions is thus reduced.

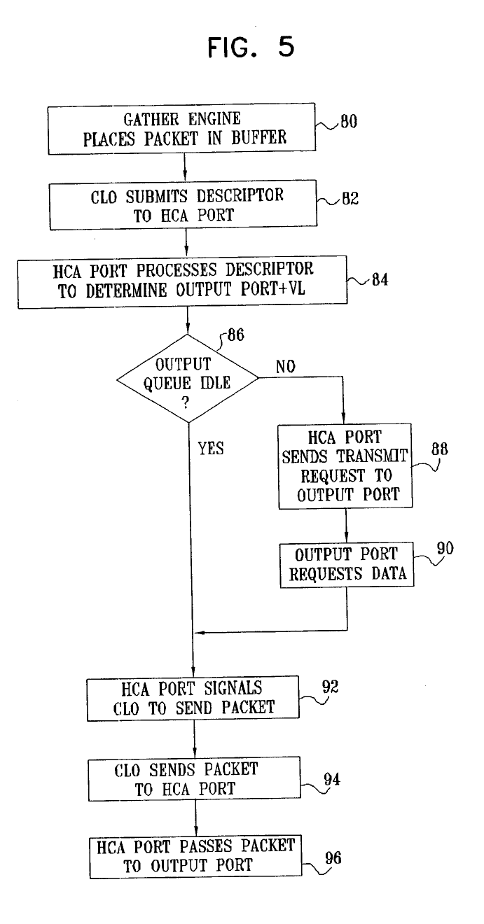

FIG. 5 is a flow chart that schematically illustrates a method for transmitting outgoing packets from HCA 28 to network 24, in accordance with a preferred embodiment of the present invention. The method builds on and summarizes aspects of HCA 28 and switch 30 described above. It is initiated when one of gather engines 60 places an output packet in its buffer 62, at a packet generation step 80. Upon entry of the packet in the buffer, CLO 42 generates a descriptor characterizing the packet, as described above, and submits the descriptor to its corresponding input port 46, at a descriptor submission step 82. Port 46 processes the descriptor to determine the output port 50 to which the packet should be sent, as well as the VL on which the packet is to be transmitted, at a port processing step 84. Meanwhile, the packet itself remains in buffer 62, and is not yet conveyed to switch 30.

When the output port and VL have been determined for the packet, input port 46 checks to determine whether the transmission queue of the output port is currently idle, i.e., whether the output port is ready to accept and transmit the packet immediately, at an idle checking step 86. If not, the input port must first submit a request to transfer the packet to the output port, at a request submission step 88. When the output port is ready to accept the packet, it returns a data request to the input port, at a data request step 90.

Once input port 46 has determined that output port 50 is ready to receive the packet for transmission, it signals CLO 42, at a transmission signaling step 92. Only at this point does CLO 42 read the appropriate packet out of buffer 62, and passes the packet to port 46, at a packet sending step 94. Since the output port has already indicated that it can accept the packet, input port 46 conveys the packet via switching core 48 directly to the output port, at a packet switching step 96. The output port then immediately transmits the packet over network 24 to its destination.

While the description above has focused on methods for handling the output packet flow from host 22 to network 24, similar techniques may be used to buffer the input flow from the network to the host. In an IB fabric, each switch port must have a declared buffer space, since flow control in maintained on a “credit” basis, i.e., each port declares and guarantees a certain amount of buffer space for each VL. For this purpose, each network port 50 may comprise its own buffer memory. Alternatively, the buffer space of switch ports 50 and HCA ports 46 may be shared (although they are exposed to network 24 as two individual buffers). This latter option has the advantages or flexible partitioning between the two buffers and reducing the total amount of buffer required.

Although preferred embodiments are described herein with reference to a particular network and hardware environment, including IB switch fabric 24, channel adapters 28 and 35, and switches 30, the principles of the present invention may similarly be applied to networks and devices of other types. Moreover, although only HCA 28 is described here in detail, the features of the HCA that are pertinent to the present invention may also be implemented, mutatis mutandis, in channel adapters of other types, such as TCA 35, as well as in network interface adapters used in other packet networks. The use in the present patent application and in the claims of certain terms that are taken from the IB specification to describe network devices, and specifically to describe HCA 28 and switch 30, should not be understood as implying any limitation of the present invention to the context of InfiniBand. Rather, these terms should be understood in their broad meaning, to cover similar aspects of-switches and interface adapters that are used in other types of networks and systems. Similarly, the term “computing device” as used herein should be understood to refer not only to host processors, but also to peripheral devices and other units capable of sending and receiving packets over a switch fabric or other network.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for interfacing a computing device with a network, comprising:
a switch, comprising a plurality of ports, including at least first and second ports; and
an interface adapter, configured to receive data from the computing device for transmission over the network, the interface adapter comprising:
packet generation circuitry, adapted to prepare a packet containing the data and destined to be transmitted onto the network through the second port;
a buffer, coupled to receive and store the packet prepared by the packet generation circuitry; and
an output interface, coupled between the buffer and the first port of the switch, and adapted to submit a notification to the first port that the packet has been prepared in the buffer, and upon receiving a response from the first port indicating that the second port is ready to transmit the packet, to convey the packet to the first port, whereupon the first port passes the packet to the second port for transmission onto the network.

2. Apparatus according to claim 1, wherein the switch is configured so that the first port, upon receiving the packet from the output interface, passes the packet to the second port substantially without buffering the packet in the switch.

3. Apparatus according to claim 1, wherein the notification submitted by the output interface comprises a descriptor identifying a destination address of the packet on the network, and wherein the switch is adapted, responsive to the descriptor, to determine that the packet should be passed to the second port for transmission.

4. Apparatus according to claim 3, wherein the descriptor further identifies a service level of the packet, and wherein the switch is adapted, responsive to the service level, to select a virtual link on which the packet is to be transmitted from the second port.

5. Apparatus according to claim 1, wherein the network comprises a switch fabric, and wherein the interface adapter comprises a channel adapter.

6. Apparatus for interfacing a computing device with a network, comprising:
an interface adapter, configured to receive data from the computing device for transmission over the network, the interface adapter comprising:
packet generation circuitry, adapted to prepare a packet containing the data;
a buffer, coupled to receive and store the packet prepared by the packet generation circuitry; and
an output interface, coupled to read the packet from the buffer; and
a switch, comprising:
a network port, connected to the network; and
an access port, coupled to receive an indication from the network port that the network port is ready to transmit the packet onto the network, and further coupled to signal the output interface, responsive to the indication, that the switch is ready to receive the packet, so that the output interface passes the packet to the access port, and the access port conveys the packet to the network port for transmission onto the network.

7. Apparatus according to claim 6, wherein the switch is configured so that the access port passes the packet to the network port substantially without buffering the packet in the switch.

8. Apparatus according to claim 6, wherein the access port is adapted to receive a notification from the output interface indicating that the packet has been prepared in the buffer, and to signal the output interface that the switch is ready to receive the packet responsive to the notification.

9. Apparatus according to claim 8, wherein the notification comprises a descriptor identifying a destination address of the packet on the network, and wherein the access port is adapted, responsive to the descriptor, to select the network port to which the packet should be passed for transmission.

10. Apparatus according to claim 9, wherein the descriptor further identifies a service level of the packet, and wherein the access port is adapted, responsive to the service level, to select a virtual link on which the packet is to be transmitted from the network port.

11. Apparatus according to claim 8, wherein the access port is adapted, responsive to the notification from the output interface, to request that the network port return the indication when it is ready to transmit the packet.

12. Apparatus according to claim 11, wherein the access port is one of a plurality of access ports that are adapted to convey packets to the network port, and wherein the network port is adapted to determine an order of transmission among the access ports and to return the indication to the access port responsive to the determined order.

13. Apparatus according to claim 6, wherein the network comprises a switch fabric, and wherein the interface adapter comprises a channel adapter.

14. A method for data communication, comprising:
preparing a packet containing data for transmission over a network via a switch having an input port and an output port connecting to the network;
storing the prepared packet in a buffer off the switch;
upon receiving an indication from the input port that the output port is ready to transmit the packet, conveying the packet to the input port; and
passing the packet through the switch from the input port to the output port for transmission onto the network.

15. A method according to claim 14, wherein passing the packet comprises receiving the packet at the input port and passing the packet through to the output port substantially without buffering the packet in the switch.

16. A method according to claim 14, wherein submitting the notification comprises submitting a descriptor identifying a destination address of the packet on the network, and wherein receiving the indication comprises generating the indication at the input port responsive to the descriptor.

17. A method according to claim 16, wherein generating the indication comprises selecting, responsive to the descriptor, one of a plurality of ports of the switch as the output port for the packet.

18. A method according to claim 16, wherein the descriptor further identifies a service level of the packet, and wherein generating the indication comprises selecting, responsive to the service level, one of a plurality of virtual links on which the packet is to be transmitted from the output port.

19. A method according to claim 14, wherein the network comprises a switch fabric, and wherein preparing the packet comprises preparing the packet in a channel adapter coupled to a computing device.

20. A method according to claim 14, wherein storing the prepared packet comprises submitting a notification to the input port that the packet is ready for transmission, and wherein the input port provides the indication that the output port is ready to transmit the packet responsive to the notification.

21. A method according to claim 20, and comprising, responsive to the notification, conveying a request from the input port to the output port to transmit the packet, and providing the indication that the output port is ready to transmit the packet upon receiving a response to the request from the output port.

22. A method according to claim 21, and comprising arbitrating at the output port among a plurality of ports of the switch having packets to transmit, so as to determine an order of transmission among the ports, and returning the response from the output port to the input port responsive to the determined order.
